(19) United States
(12) Patent Application Publication
(10) Pub. No.: US 2009/0185711 A1
(43) Pub. Date: Jul. 23, 2009

(54) SPEAKER UNIT

(75) Inventors: Akira SHIGETA, Hino-shi (JP); Masakatsu SAKAMOTO, Hachiouji-shi (JP); Masaaki YUSA, Mitaka-shi (JP); Satoshi ISOYAMA, Hino-shi (JP)

Correspondence Address: ERIC ROBINSON, PMB 955, 21010 SOUTHBANK ST., POTOMAC FALLS, VA, 20165, US

(73) Assignee: KABUSHIKI KAISHA KENWOOD, Tokyo (JP)

(21) Appl. No.: 12/351,107

(22) Filed: Jan. 9, 2009

(30) Foreign Application Priority Data
Jan. 17, 2008 (JP) 2008-008459

(51) Int. Cl. H04R 1/00

(52) U.S. Cl. 381/413

(57) ABSTRACT

To provide a speaker unit capable of being thinned much further. A speaker unit 1 includes a voice coil 6 through which an input signal is passed, a voice coil bobbin 5 for converting the input signal flowing through the voice coil 6 into a mechanical reciprocating movement, a diaphragm 2 connected to either one side of said voice coil bobbin 5 in the reciprocating vibration direction; and a damper not connected to the voice coil bobbin 5 and connected to an outer edge portion of the diaphragm 2 and suppressing a rolling phenomenon of the voice coil bobbin 5.

### CROSS-REFERENCES TO RELATED APPLICATIONS

This application also claim the benefit of priority from Japanese Patent Applications No. 2008-008459 filed on Jan. 17, 2008, the entire content of which is incorporated herein by reference.

### BACKGROUND OF THE INVENTION

1. Field of the Invention

The present invention relates to speaker units, and in particular, to a thin type speaker unit having a large diameter.

2. Related Background Art

In recent years, for example, along with the popularization of an extremely thin type TV such as a liquid crystal screen TV and a multichannel car stereo, and the like, a request for thinness of speaker units has been increasing. As an example of the conventional thin type speaker unit, a speaker shown in FIG. 5 has been proposed (for example, Japanese Patent Application Laid-Open No. 2006-191252).

A basic structure of the conventional thin type speaker unit will be described with reference to FIG. 5.

A diaphragm 121 includes an inner conical portion 122 opened upward of the figure which is a speaker front direction, an outer conical portion 123 opened downward which is a back face direction, and a connecting portion 124 connecting both of the conical portions. An outer edge of the outer conical portion 123 is provided with an edge 125. Inside the inner conical portion 122, a center cap 126 is bonded. Downward the center cap 126, a connecting portion 127 of the inner most end of the diaphragm 121 is connected with one end of a voice coil bobbin 128. An overlapping area 137 in the midst of the voice coil bobbin 128 is bonded with a damper 129. The damper 129 holds the voice coil bobbin 128 at its central axial line, while allowing a mechanical reciprocating movement (vibration) converted from an electrical input by conversion means 130 located below thereof.

The conversion means 130 includes a voice coil 131 wound around at the bottom of the voice coil bobbin 128, and a magnetic field portion 132 providing a strong magnetic field to the voice coil 131. The magnetic field portion 132 includes a magnet 133 serving as a permanent magnet, a plate 134, and a pole piece (yoke) 135, thereby forming a magnetic circuit of an outer magnetic type. The voice coil bobbin 128 is inserted into an upright portion of the pole piece 135, and an electromagnetic force corresponding to the current is given to the voice coil 131 from the magnetic field inside a magnetic space (magnetic gap), which is formed between the inner peripheral surface of a penetration-hole formed in the plate 134 and the outer surface of the upright portion of the opposing pole piece 135. An outer edge side of the edge 125, the outer edge side of the damper 129, and the bottom of the pole piece 135 are supported by a frame 136.

### SUMMARY OF THE INVENTION

Now, in such conventional speaker, by vibrating (vertically in FIG. 5) the voice coil bobbin 128 integrally formed with the voice coil 131 which converts an electrical input into a mechanical reciprocating vibration, the diaphragm 121 is moved, thereby to output a voice to the outside of the speaker. At this time, though the voice coil bobbin 128 is ideally vibrated only in the vertical direction of FIG. 5, in reality, due to the resonance of a vibration system (the edge 125, the diaphragm 121, and the voice coil bobbin 128) and problems in manufacturing, and the like, a so-called rolling phenomenon occurs, in which a gravity position of the vibration system is displaced, and the voice coil bobbin 128 moves (vibrates) in a direction other than the vertical direction.

In this manner, the vertical movement of the voice coil bobbin 128 moves in the direction other than vertical due to the resonance and the like of the edge 125+the diaphragm 121+the voice coil 131. To prevent this rolling phenomenon, the voice coil bobbin 128 is connected with the damper 129, thereby to secure straight-advancing property of the voice coil bobbin 128. Unless the straight-advancing property of the voice coil bobbin 128 is secured, the voice coil bobbin 128 is brought into contact with the plate 134 and the like, thereby to cause abnormal noise and damage. Further, when the magnetic gap is made large so as not to cause such situation, the magnetic force is reduced to be followed by the reduction of sound pressure.

To solve such problem, that is, to suppress the vibration other than one way direction, and to hold the voice coil bobbin 128, the damper 129 is provided.

However, to bond the damper 129 to the voice coil bobbin 128 (bonding at one point is difficult, and generally, a method of a so-called padding is used), a broadish space (the overlapping area 137) to bond the damper to the voice coil bobbin 128 is required. Further, in the speaker of a wide diameter, since a vibration width in one way direction of the voice coil bobbin 128 reaches even several tens mm, unless the distance between the magnetic gap and the damper 129 takes into consideration this vibration width also, the damper 129 interferes with other members, thereby to cause damage and abnormal noise. Hence, it is necessary to provide a sufficient space for securing the vibration range of the damper 129 inside the speaker unit 120.

That is, in the conventional speaker, to suppress the rolling phenomenon, the damper 129 is required, and a broad overlapping area 137 for adhering this damper 129 to the voice coil bobbin 128 is required. Further, a space for securing the vibration range of the damper 129 is required, and this becomes a big obstacle to the thinness of the speaker.

The present invention has been carried out in view of such problems, and an object of the invention is to provide a speaker unit capable of being further thinned.

To achieve the above described object, the speaker unit of the present invention includes a voice coil through which an input signal, a magnetic circuit disposed at a predetermined interval so as to sandwich the voice coil and the voice coil bobbin from the inside and outside, a diaphragm connected to any of upper and lower sides of the voice coil bobbin, and a damper not connected to the voice coil bobbin and connected to the outer edge portion of the diaphragm and suppressing a rolling phenomenon of the voice coil bobbin.

Further, the speaker unit of the present invention, in addition to the above described invention, has a damper which is configured by an inner peripheral plate and an outer peripheral plate concentrically formed by two circular thin plates different in diameter, and a connecting plate for connecting the inner peripheral plate and the outer peripheral plate, and a diameter of the inner periphery of the inner peripheral plate is configured to be larger than the diameter of the voice coil.

Further, the speaker unit of the present invention, in addition to the above described invention, has a damper which is printed or bonded with a conductive layer, and is preferably configured such that an input signal is supplied from the damper to the voice coil.

Further, the speaker unit of the present invention, in addition to the above described invention, has a damper having preferably a hybrid structure made of a plurality of layers different in materials.

Further, the speaker unit of the present invention, in addition to the above described invention, has a damper whose shape in the connecting portion between the damper and the diaphragm is preferably taper-shaped to conform to the shape of the diaphragm.

According to the present invention, it is possible to make a speaker unit further thinned.

### BRIEF DESCRIPTION OF THE DRAWINGS

FIG. 1 is a sectional view showing the configuration of a speaker unit in the embodiment of the present invention.

FIG. 2 is an exploded sectional view of the speaker unit shown in FIG. 1.

FIG. 3 is an exploded perspective view of the speaker unit shown in FIG. 1.

FIG. 4 is a view showing an example of the configuration of the butterfly damper which is one construction member of the speaker unit shown in FIG. 1.

FIG. 5 is a sectional view showing the configuration of a conventional thin type speaker unit.

### DESCRIPTION OF THE PREFERRED EMBODIMENTS

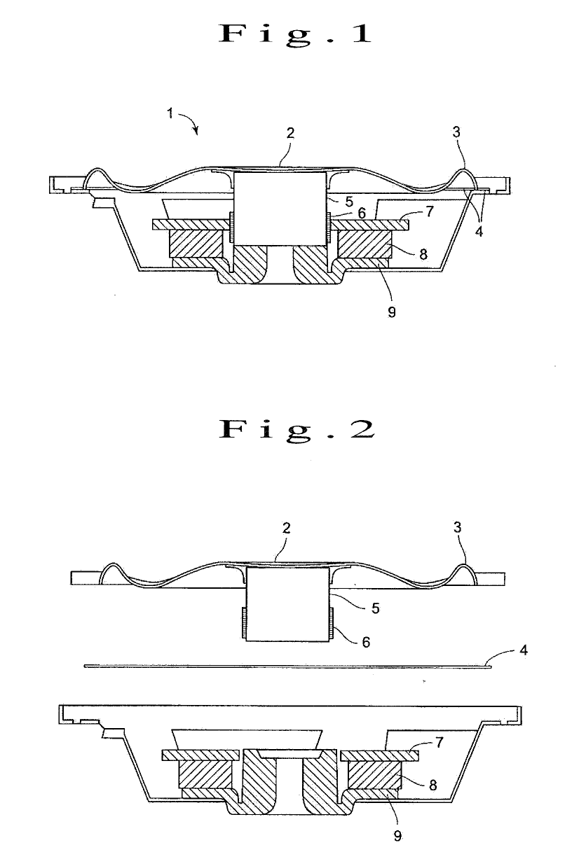

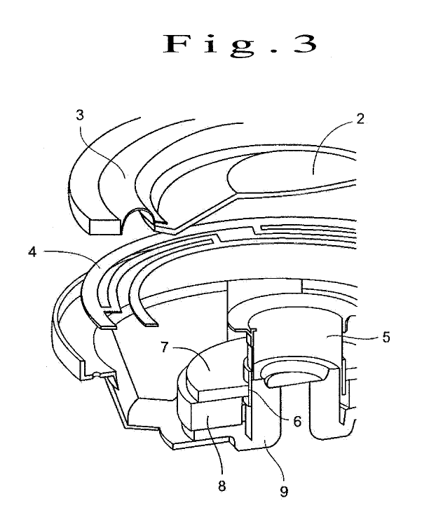

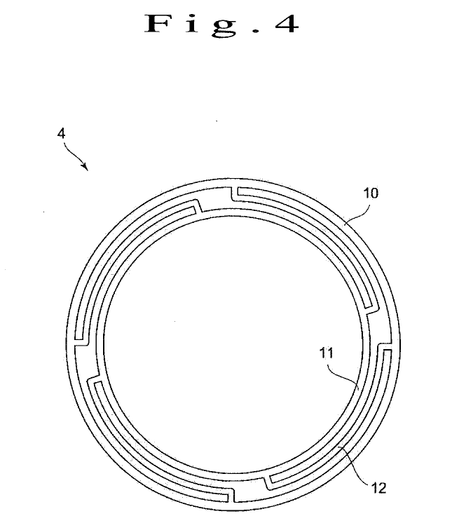

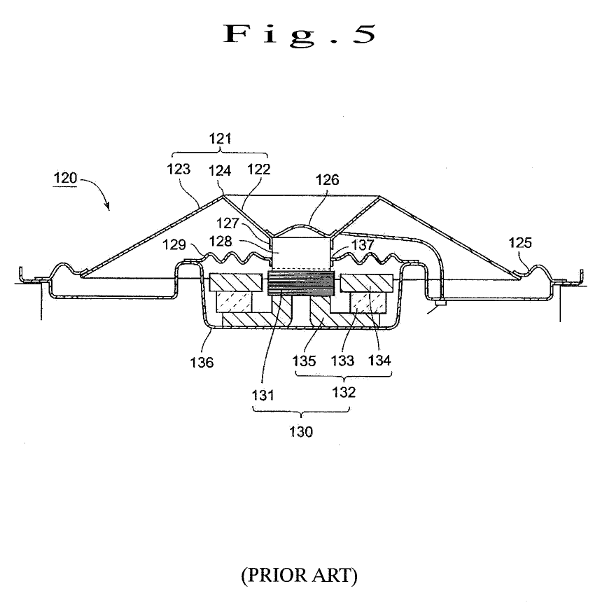

The basic structure of a speaker unit according to the embodiment of the present invention will be described below. FIG. 1 is a sectional view showing a configuration of a speaker unit in the embodiment of the present invention, FIG. 2 is an exploded sectional view of the speaker unit in the embodiment of the present invention, and FIG. 3 is an exploded perspective view of the speaker unit in the embodiment of the present invention. Further, FIG. 4 is a view showing an example of the configuration of a butterfly damper which is one construction member of the speaker unit.

As shown in FIGS. 1, 2, and 3, a speaker unit 1 includes a diaphragm 2, an edge 3, a butterfly damper 4 which is one embodiment of a damper, a voice coil bobbin 5, a voice coil 6, a top plate 7, a magnet 8, and a pole piece 9. A magnetic circuit is formed by the top plate 7, the magnet 8 and the pole piece 9.

The diaphragm 2 is connected to an inner conical portion opened upward in the figure which is a front surface direction of the speaker unit 1 and the outer periphery of the inner conical portion, and includes an outer conical portion opened downward which is a back face direction. The outer edge of the outer conical portion is provided with the edge 3. Below the edge 3, the butterfly damper 4 is provided. The butterfly damper 4 and the outer conical portion of the diaphragm 2 are mutually connected. The butterfly damper 4 holds the voice coil bobbin 5 on its central axial line (not shown), while allowing a reciprocating movement (reciprocating vibration) of the voice coil bobbin 5 based on the input signal flowing through the voice coil 6 which is wound around the voice coil bobbin 5.

On the outside of the voice coil 6, the top plate 7 and the magnet (preferably a permanent magnet) 8 are loaded and disposed at an interval (magnetic gap) in order from above as shown in FIG. 1. The magnet 8 is disposed on a pole piece (referred to also as a yoke) 9. The top plate 7, the magnet 8, and the pole piece 9 forms a magnetic circuit of an outer magnetic type. The voice coil bobbin 5 is inserted into the upright portion of the pole piece 9, and an electromagnetic force corresponding to the input signal is given to the voice coil 6 by an open magnetic circuit flowing inside the magnetic gap, which is formed between an inner peripheral surface of the penetration hole formed approximately in the center of the top plate 7 and an outer peripheral surface of the upright portion of the pole piece 9 opposed to the inner peripheral surface. The outer edge side of the edge 3, the outer edge side of the butterfly damper 4, and the bottom of the pole piece 9 are supported by a frame.

As shown in FIG. 4, the butterfly damper 4 is integrally molded and configured by the inner peripheral plate 11 concentrically disposed with two circular thin plates different in diameter, the outer peripheral plate 10, and a connecting plate 12 for connecting the inner peripheral plate 11 and the outer peripheral plate 10. As described above, the butterfly damper 4 is connected to the diaphragm 2, and is not connected to the voice coil bobbin 5. Hence, the butterfly damper 4, even if going up and down, has a low risk of contacting the top plate 7, the magnet 8 or the pole piece 9, and the like. Consequently, the thinness of the speaker unit 1 can be attempted. Further, since the butterfly damper 4 is not connected to the voice coil bobbin 5, it becomes useless to provide an overlapping area on the voice coil bobbin 5, so that the speaker unit 1 can be further thinned.

Further, since a length in the vertical direction of the voice coil bobbin 5 can be made short, a gravity center position of a vibration system is made close to a drive point (voice coil 6), thereby making it more easier to avoid a rolling phenomenon. Further, since a necessity of attaching the damper to the voice coil bobbin 5 is eliminated, the voice coil bobbin 5 can be made light in weight, so that a voice response to the input signal can be improved.

Further, as the material of the butterfly damper 4, glass epoxy and resin such as bakelite or metal such as aluminum and stainless can be adopted. For example, when the butterfly damper 4 made of resin is adopted, the butterfly damper becomes soft and light in weight. On the other hand, when the metal made butterfly damper 4 is adopted, the butterfly damper 4 becomes hard and heavy in weight. In this manner, by changing the material of the butterfly damper 4, acoustic characteristics of the speaker unit 1 can be changed.

Further, by printing or bonding a copper foil and the like on the butterfly damper 4 or coating it with a conductive coating, the butterfly damper 4 may be turned into a so-called [conductive damper]. In the present embodiment, since the butterfly damper 4 is not connected to the voice coil bobbin 5, to supply the input signal to the voice coil 6, a terminal provided in the frame of the speaker unit 1 and the copper foil of the butterfly damper 4 are connected, and two methods of either (1) connecting the input signal to the voice coil 6 by using a tinsel wire from the inside of the butterfly damper 4 or (2) printing the copper foil on the back of the diaphragm 2 and introducing the input signal finally to the voice coil 6 through the back of the diaphragm 2 can be adopted.

By adopting such configuration, it is possible to omit the tinsel wire or make it short. Further, since there is no possibility of the tinsel wire at least extending to the voice coil 5 of the center portion from the outside (frame terminal) of the speaker unit 1, the driving members (the voice coil, the damper, and the diaphragm) of the speaker are also not brought into contact with the tinsel wire, and the possibility of generating abnormal noise can be reduced.

Further, the shape of the butterfly damper 4 side in the connection portion between the butterfly damper 4 and the diaphragm 2 may be taper-shaped by conforming to the shape of the diaphragm 2. Because of this taper-shape, the connection of the butterfly damper to the diaphragm 2 is made by a bonding agent, but this can be also used as an overlapping area, and therefore, bonding strength can be also increased.

Further, the butterfly damper 4 may be turned into a hybrid structure having a plurality of layers different in materials. By configuring the butterfly damper 4 by the plurality of layers different in materials, a span of adjustable range of tone quality can be expanded depending on a combination of the layers.

In place of the butterfly damper 4, a damper of the configuration concentrically repeating unevenness may be adapted.

What is claimed is:

1. A speaker unit, comprising:
a voice coil through which an input signal flows;
a cylindrical voice coil bobbin around which said voice coil is wound and fixed;
a magnetic circuit disposed on the inside and outside of said voice coil and said voice coil bobbin, at a predetermined interval;
a diaphragm connected to either one of upper or lower end of said voice coil bobbin; and
a damper free from said voice coil bobbin and connected to an outer edge portion of the diaphragm to suppress a rolling phenomenon of said voice coil bobbin.

2. The speaker unit according to claim 1, wherein said damper is configured of an inner peripheral plate and an outer peripheral plate concentrically formed by two circular thin plates having different diameters, and a connecting plate for connecting said inner peripheral plate and outer peripheral plate, and a diameter of the inner periphery of said inner peripheral plate is configured to be larger than the diameter of said voice coil.

3. The speaker unit according to claim 1, wherein a conductive layer is printed or bonded on said damper, and said damper is configured such that an input signal is supplied from the damper to said voice coil.

4. The speaker unit according to claim 1, wherein said damper has a hybrid structure made of a plurality of layers made from different materials.

5. The speaker unit according to claim 1, wherein a shape of said damper in the connecting portion between said damper and said diaphragm is taper-shaped to conform to the shape of said diaphragm.
